(19) United States
(12) Patent Application Publication
(10) Pub. No.: US 2015/0178876 A1
(43) Pub. Date: Jun. 25, 2015

(54) RESOLVING ORPHAN OR INACTIVE ACCOUNTS

(71) Applicant: International Business Machines Corporation, Armonk, NY (US)

(72) Inventors: Kaushal K. Kapadia, Pune (IN); Dinesh T. Jain, Pune (IN)

(21) Appl. No.: 14/317,349

(22) Filed: Jun. 27, 2014

Related U.S. Application Data
(63) Continuation of application No. 14/138,681, filed on Dec. 23, 2013.

(51) Int. Cl. G06Q 50/26; G06Q 10/00

(52) U.S. Cl. CPC G06Q 50/265; G06Q 10/00

(57) ABSTRACT

In a method for resolving orphan accounts, information about at least one account on a computing system is received. One or more processors determine, from the received information, that a first potential orphan account exists on the computing system. One or more processors notify a first potential account owner of the first potential orphan account about the existence of the first potential orphan account. One or more processors receive an ownership claim for the first potential orphan account, wherein the ownership claim indicates that the first potential account owner is an actual owner of the first potential orphan account, and the one or more processors determine whether the ownership claim is legitimate.

### FIELD OF THE INVENTION

The present invention relates generally to the field of identity management and more particularly to user account administration.

### BACKGROUND OF THE INVENTION

By utilizing user accounts people can simultaneously share a computer's file system, applications, and processors. A few attributes of a user account include: (i) file access privilege for a user; (ii) a user is allowed to make changes to components of the computer system; and (iii) user preferences, such as desktop background or color theme can be modified. Conventionally, there are at least three different types of accounts: (i) standard; (ii) administrator; and (iii) guest. Each account type gives the user a different level of control over the computer. The standard account is a permanent long-term account for everyday computing. The administrator account provides the most control over the computer, and should only be given when necessary. The guest account is primarily for users who need temporary access to the computer.

Enterprise computer systems contain large numbers of servers that are often geographically distributed. These systems may be accessible by a large numbers of users, possibly numbering in the hundreds of thousands. Users with data access authorization include: information technology personnel, operational personnel such as account managers, general users of the enterprise computer system, proxy users, and possibly guest users. Users of enterprise systems come and go, and as they depart they leave data accounts open to be dealt with by the administrators. Accounts without active users become defunct and consequently without a valid user. An orphan account is an operational account without a valid user.

### SUMMARY

Aspects of an embodiment of the present invention disclose a method, computer program product, and computing system for resolving orphan accounts. The method includes receiving information about at least one account on a computing system. The method further includes one or more processors determining, from the received information, that a first potential orphan account exists on the computing system. The method further includes one or more processors notifying a first potential account owner of the first potential orphan account about the existence of the first potential orphan account. The method further includes one or more processors receiving an ownership claim for the first potential orphan account, wherein the ownership claim indicates that the first potential account owner is an actual owner of the first potential orphan account. The method further includes one or more processors determining whether the ownership claim is legitimate.

### BRIEF DESCRIPTION OF THE SEVERAL VIEWS OF THE DRAWINGS

FIG. 1 is a diagram of a network computer environment, in accordance with one embodiment of the present invention.

FIG. 2A is a flowchart depicting operational steps of the gather orphan account program, in accordance with one embodiment of the present invention.

FIG. 2B is a flowchart is a flowchart depicting operational steps of the self-claim orphan account program, in accordance with one embodiment of the present invention.

FIG. 3 depicts a block diagram of components of the computers of FIG. 1, in accordance with one embodiment of the present invention.

### DETAILED DESCRIPTION

Orphan accounts represent serious security risks to an enterprise. Per compliance regulations, such as Sarbanes-Oxley Act and Gramm-Leach-Bliley Act, it is required for organizations to ensure the integrity of access across its enterprise systems. Hence, it is essential for a management system to detect and handle the orphan accounts residing on the resources.

Traditionally, when an administrator is confronted with possible orphan accounts, the administrator either assigns the user to a general temporary account and waits until he has determined that the user's information can be deleted. In some instances, orphan accounts are valid infrequently used accounts. Subsequently, the user eventually attempts to access the account, which is flagged as orphan, and the administrator must reverse the status of the account from orphan to valid to allow the user access.

On type of orphan account is an account created out-of-process. Out-of-process means that the account was created by averting proper account creation procedures. Accounts created ad hoc, or accounts leftover before the proper account creation procedures were instituted, are accounts created out-of-process. When an organization utilizes an Identity Management system (IDM), the IDM should create the account within the approved account creation process.

An Identity Management system (IDM) is software that helps administrators manage user accounts. An IDM enables organizations to effectively manage the cradle-to-grave lifecycle of user identities across their enterprise resources. Many the IDMs provide the following capabilities: (i) automated user accounts provisioning and de-provisioning on enterprise resources; (ii) role based access control; (iii) orphan accounts management on enterprise resources; (iv) comprehensive policy configuration; (v) the capability to build self service user interface for end users; (vi) audit and compliance features; and (vii) support for most of the enterprise resources such as: databases, lightweight directory access protocol (LDAP), operating systems, web applications, and mail servers.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer-readable medium(s) having computer-readable program code/instructions embodied thereon.

Any combination of computer-readable media may be utilized. Computer-readable media may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of a computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java®, Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer-implemented process such that the instructions which execute on the computer or other programmable apparatus provide processes for implementing the functions/acts specified in the flowchart and/or block diagram block or blocks.

The present invention will now be described in detail with reference to the Figures. The following figures provide an illustration of one embodiment. The embodiment, taken in part or in whole, does not imply any limitations with regard to the environments in which different embodiments may be implemented.

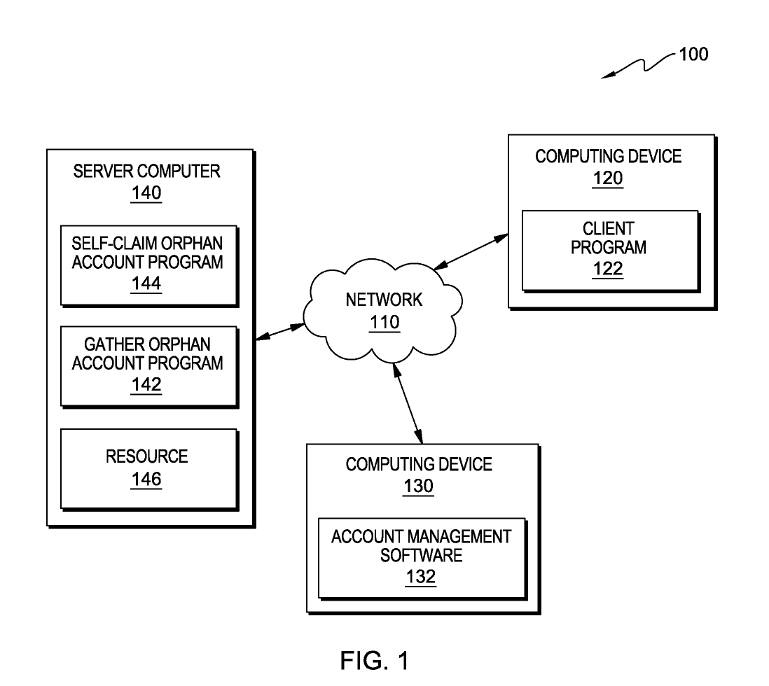

FIG. 1 depicts a diagram of network computer environment 100, in accordance with one embodiment of the present invention. Network computer environment 100 includes computing device 120, computing device 130, and server computer 140, all interconnected over network 110. Network 110 may be a local area network (LAN), a wide area network (WAN) such as the Internet, any combination thereof, or any combination of connections and protocols that will support communications among computing device 120, computing device 130, and server computer 140, in accordance with embodiments of the invention. Network 110 may include wired, wireless, or fiber optic connections. Network computer environment 100 may include additional computers or other devices not shown.

Computing device 120 is used by a potential account holder to access self-claim orphan account program 144 on server computer 140 and to claim resource 146. A potential account holder utilizes client program 122 to access, via network 110, self-claim orphan account program 144. In the depicted embodiment, client program 122 is contained on computing device 120. Computing device 120 may be a management server, a web server, or any other electronic device or computing system capable of receiving and sending data. In another embodiment, computing device 120 may be a laptop computer, tablet computer, netbook computer, personal computer (PC), a desktop computer, a personal digital assistant (PDA), a smart phone, or any programmable electronic device capable of receiving and sending data.

In various embodiments, computing device 120 is the same computer as either computing device 130 or server computer 140, connected to other computer devices (not shown). In other embodiments, computing device 120 communicate to other computers on network 110 in a peer-to-peer fashion, where all computers share equivalent responsibility for processing data. In other embodiments, computing device 120 may represent a server computing system utilizing multiple computers as a server system, such as in a cloud computing environment.

In the depicted embodiment, client program 122 allows a potential orphan account owner to communicate with self-claim orphan account program 144, on server computer 140 in an attempt to claim resource 146. Client program 122 can be, but is not limited to: (i) conventional browser able to communicate with self-claim orphan account program 144; (ii) software plug-in to a conventional browser able to communicate with self-claim orphan account program 144; (iii) an off-the-shelf program or custom program which either is able to communicate with self-claim orphan account program 144. In various embodiments, client program 122 is located on computing device 130, server computer 140, or another device, not shown, as long as the host device can communicate with computing device 120 and server computer 140.

In the depicted embodiment, a potential orphan account owner is sometimes referred to as a user. Potential orphan account owner include, but are not limited to: (i) a user of applications, such as client program 122; (ii) an administrator of a computer system; or (iii) a developer of a computer system. A potential orphan account owner can, and probably does, hold multiple accounts on various computer systems. For example, a potential orphan account owner may have accounts on an email server, a Virtual Private Network (VPN) server, and several application servers.

Computing device 130 is used by an account administrator to grant or deny a claim for an account by a potential account holder for resource 146. An account administrator utilizes account management software 132 to access to grant or deny the claim. In the depicted embodiment, account management software is contained in computing device 130. Computing device 130 may be a management server, a web server, or any other electronic device or computing system capable of receiving and sending data. In another embodiment, computing device 130 may be a laptop computer, tablet computer, netbook computer, personal computer (PC), a desktop computer, a personal digital assistant (PDA), a smart phone, or any programmable electronic device capable of receiving and sending data.

In various embodiments, computing device 130 is the same computer as either computing device 120 or server computer 140, connected to other computer devices (not shown). In other embodiments, computing device 130 communicate to other computers on network 110 in a peer-to-peer fashion, where all computers share equivalent responsibility for processing data. In other embodiments, computing device 130 may represent a server computing system utilizing multiple computers as a server system, such as in a cloud computing environment.

In the depicted embodiment, account management software 132 provides the ability for an account administrator to grant or deny a claim for an account by a potential account holder for resource 146. Account management software 132 receives a request from self-claim orphan account program 144 and prompts an account administrator to grant or deny a claim. In some embodiment, account manager software 132 may be software running in a conventional browser. In various embodiments, account manager software 132 is located on server computer 140.

Account management software 132 may display information that would facilitate a decision by the account administrator. Account management software 132 sends the decision back to self-claim orphan account program 144. The account administrator may perform additional duties, such as: (i) analyzing system logs and identifying potential issues with computer systems; (ii) introducing and integrating new technologies into existing data center environments; (iii) performing routine audits of systems and software; (iv) applying operating system updates, patches, and configuration changes; (v) installing and configuring new hardware and software; and (vi) adding, removing, or updating user account information, and resetting passwords. In the depicted embodiment, an account administrator manages access for at least one, but probably several, of the resources (e.g. email, virtual private networks, application servers, etc.). In other embodiments, the person responsible for approving changes in account ownership, and is a proxy for an account administrator, includes, but is not limited to: (i) a manager; (ii) a co-worker; and (iii) an automated system.

Server computer 140 provides a potential account holder access to self-claim orphan account program 144. In the depicted embodiment, server computer 140 contains gather orphan account program 142, self-claim orphan account program 144, and resource 146. Server computer 140 may be a management server, a web server, or any other electronic device or computing system capable of receiving and sending data. In another embodiment, server computer 140 may be a laptop computer, tablet computer, netbook computer, personal computer (PC), a desktop computer, a personal digital assistant (PDA), a smart phone, or any programmable electronic device capable of receiving and sending data.

In various embodiments, server computer 140 is the same computer as either computing device 120 or computing device 130, connected to other computer devices (not shown). In other embodiments, server computer 140 communicates to other computers on network 110 in a peer-to-peer fashion, where all computers share equivalent responsibility for processing data. In other embodiments, server computer 140 may represent a server computing system utilizing multiple computers as a server system, such as in a cloud computing environment.

In one embodiment, gather orphan account program 142 provides the ability to determine potential orphan accounts. Gather orphan account program 142 notifies potential orphan account owners that they have an account that is labeled as potentially orphaned. To help determine which accounts are potential orphaned, gather orphan account program 142 has access to account logs that are available on a computer system, such as server computer 140. There exists an account log for each computer system that requires a user account. The account logs contain information such as, which user logged into the system, when a user logged in, from which machine did the user login, and technical details of the machine network connection. A log file can be utilized to determine who has left the company and consequently, the administrator would label such an account as defunct and orphaned. The discovery process can be automated into an adoption policy.

An adoption policy implements rules for accounts and users of accounts. An adoption policy provides a means to reconcile valid accounts on the enterprise, which also results in all other accounts being invalid, defunct, and possibly eventually becoming orphaned. For example, on an email server the account naming convention may be to use firstname.lastname (first and last name of the user separated by a dot). The adoption policy could be as simple as, accounts with proper naming conventions accessed in the last 90 days are valid accounts, while all others are potential orphan accounts. The administrator institutes the adoption policy, which runs periodically (possibly once a day). The policy discovers several user accounts that either do not follow the naming convention, or not accessed in the last 90 days. Gather orphan account program 142 may contain software that functions similarly to an adoption policy, or may simply manage the execution of an adoption policy.

In one embodiment, self-claim orphan account program 144 allows potential orphan account owners to self-claim a potential orphan account and provides an approval process for approving the labeling change of a potential orphan account to a valid account. Self-claim orphan account program 144 provides potential orphan account holders a method of access, such as login mechanism, and to select potential orphan accounts that have been labeled potentially orphaned by gather orphan account program 142. Self-claim orphan account program 144 communicates with account management software 132 to acquire approval for granting a potential orphan account holder's claim.

In one embodiment, resource 146 is any application that requires account user authentication for access to the application. A potential orphan account owner has, or has had, access to resource 146, currently, or in the past, and wants to retain access. When gather orphan account program 142 executes it will examine log files that were produced when resource 146 was accessed. Examples of resource 146 include, but are not limited to: email, personnel records, and a VPN program.

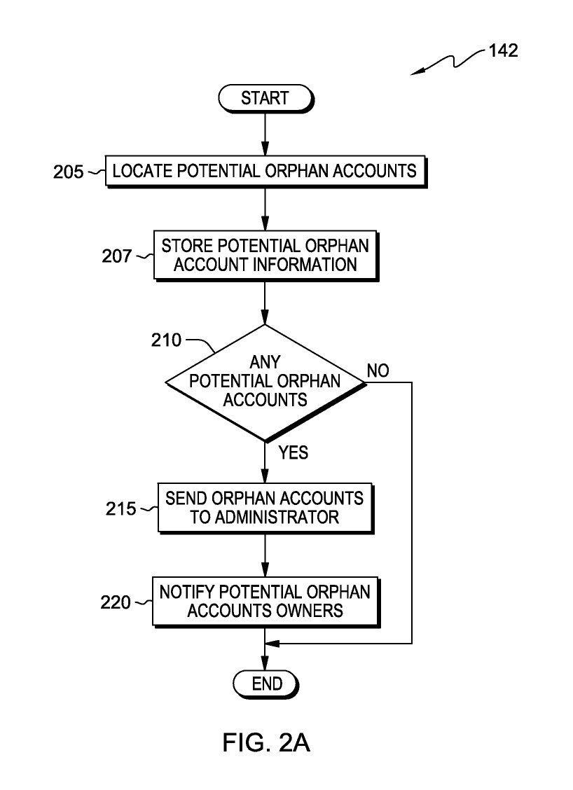

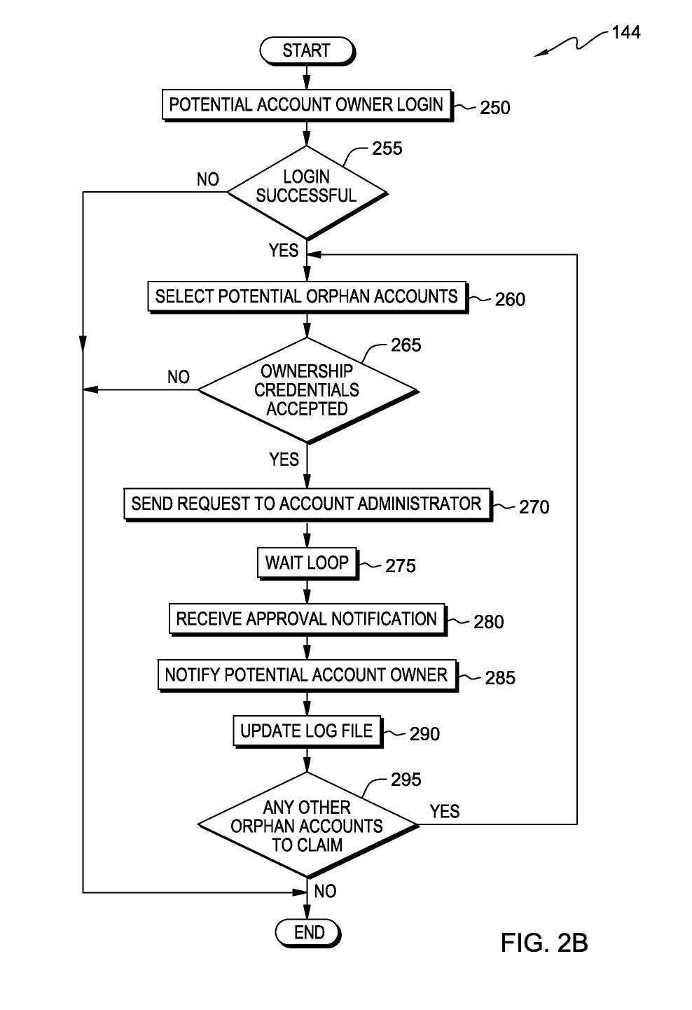

FIG. 2A is a flowchart depicting operational steps of gather orphan account program 142, in accordance with one embodiment of the present invention. Gather orphan account program 142 is invoked either by an administrator or automatically. For instance, gather orphan account program 142 can be scheduled to run at a specific time each day, once every week, or whenever the adoption policy states.

In step 205, gather orphan account program 142 locates potential orphan accounts. In one embodiment, gather orphan account program 142 accesses the log files on server computer 140 and extracts pertinent account information. As previously discussed, gather orphan account program 142 may utilize an adoption policy to locate potential orphan accounts and to extracts pertinent account information. Pertinent account information includes, but not limited to: account owner's name, login information, when the account was last accessed and by who, by which computer the account was accessed, owner's birthdate, owner's home address, and other information that may have been gathered when the account was created. Gather orphan account program 142 labels, or flags, accounts that do not adhere to adoption policy rules as potentially orphaned. The depicted embodiment allows the original user to continue owning the potentially orphaned account. In other embodiments, the original user is prevented access to the potentially orphaned account.

In step 207, gather orphan account program 142 stores potential orphan account owner identification information in a data file. Gather orphan account program 142 takes the extracted pertinent account information, acquired in step 205, and stores it in a data file. In subsequent steps, the data file information is sent to account management software 132, and additionally used in self-claim orphan account program 144. Sometime later, potential orphan account owners can be presented with ownership credentials questions from self-claim orphan account program 144. The ownership credentials questions allow a potential account owner to validate his account ownership.

Furthermore, gather orphan account program 142 includes in the aforementioned data file self-claim access credentials for the potential orphan account owner to later access self-claim orphan account program 144. Note, that the purpose of self-claim access credentials is different from the purpose of ownership credentials. Self-claim access credentials are presented to allow the user entry to self-claim orphan account program 144, while ownership credential questions are presented to the user to substantiate his ownership of a potential orphan account. One example of self-claim access credentials is a random string of alphanumeric characters, which are generated as needed. Sometime later, when the potential orphan owner attempts to login to self-claim orphan account program 144 the potential orphan owner is requested to enter answers to the self-claim access credentials questions.

Furthermore, gather orphan account program 142 places the valid and potential orphan accounts in an audit log along with the identification information, so that there is an artifact of all the information that has been gathered.

Before gather orphan account program 142 labels the account as possibly being orphaned, gather orphan account program 142 checks a data file of previously potential orphan accounts that have been determined valid by a previous invocation of self-claim orphan account program 144. When an account is infrequently used the account may be flagged each time gather orphan account program 142 is invoked. To alleviate performing re-work by the potential account owner these potential orphan accounts that have been approved by a previous invocation of self-claim orphan account program 144 are removed from the list of potential orphan accounts.

In decision step 210, gather orphan account program 142 determines if there were any accounts that are potential orphan accounts. Gather orphan account program 142 checks the data file, created in step 207, and determines whether there are any potential orphan accounts stored. It is possible that there are no accounts found to be potential orphan accounts. When there are no potential orphan accounts gather orphan account program 142 terminates (decision step “NO” branch). If there is at least one potential orphan account, gather orphan account program 142 transitions to step 215 (decision step “YES” branch).

In step 215, gather orphan account program 142 sends pertinent account information to account management software 132. Sending the pertinent account information may be in the form of an Extensible Markup Language (XML) message, as someone skilled in the arts would recognize. In one embodiment, the pertinent account information is stored in a data file on the computing device 130 and accessed by account manager software 132. At the account administrator request, account manager software 132 will present potential orphan account information to the account administrator, so that he can approve the self-claim request, or deny the self-claim request, as the case may be.

In step 220, gather orphan account program 142 notifies potential account owners that they have an account that is labeled as orphaned. One method of notification is by sending an email to the potential orphan account owner's address. Various embodiments may use different methods to notify potential account owners, such as, a pop-up when accessing other accounts within the network, a voicemail, or an instant message. Furthermore, various embodiments may use phraseology in the notification. For example, the potential orphan account owner may be notified that the account is labeled as “orphaned,” “invalid,” “used too infrequently,” and/or “does not follow naming conventions.” The notification includes answers to the self-claim access credentials questions, and may include instructions as to how to claim the potential orphan account. After completion of step 220 gather orphan account program 142 terminates.

FIG. 2B is a flowchart is a flowchart depicting operational steps of self-claim orphan account program 144, in accordance with one embodiment of the present invention. In the depicted embodiment, self-claim orphan account program 144 is invoked by a potential orphan account owner wanting to self-claim an orphan account. Self-claim orphan account program 144 can be invoked when the potential orphan account owner enters address of self-claim orphan account program 144 in a browser. In other embodiments, self-claim orphan account program 144 has been invoked and is suspended until a potential orphan account owner presses a button, possibly on a webpage, to activate the program to self-claim an orphan account.

In step 250, self-claim orphan account program 144 presents the potential orphan account owner with a login mechanism. The potential orphan account owner will be presented with a login screen, as someone skilled in the arts would recognize, when the potential orphan account owner clicks on a hyperlink to display the login screen. The potential orphan account owner enters the answers to the self-claim access credentials questions sent to him by gather orphan account program 142.

In decision step 255, self-claim orphan account program 144 determines if the self-claim access credentials answers are accepted by self-claim orphan account program 144. The true answers to the self-claim access credentials are stored in a data file created by gather orphan account program 142. The self-claim orphan account program 144 compares the answers from the potential orphan account owner to the self-claim access credentials answers stored in the data file. If the authorization credentials answers are accepted, self-claim orphan account program 144 transitions to step 260 (decision step “YES” branch). If the authorization credentials answers are not accepted by self-claim orphan account program 144, self-claim orphan account program 144 can transition to one of the following steps: (i) step 255, present the login screen again; (ii) step 255, present the login screen again and decrement an attempts counter to limit the number of times the potential orphan account owner is presented with a login screen; (iii) or terminate, or suspend, and present a failure authorization message to the potential account owner (decision step “NO” branch).

In step 260, self-claim orphan account program 144 displays potential orphan accounts to the potential orphan account owner. The display can be as simple as a dropdown control box. The potential orphan account owner would select which potential orphan account he wanted to claim. After selecting the potential orphan account the potential orphan account owner is requested to answer the ownership credentials questions. The display can include additional information that would assist the potential orphan account owner to remember the ownership credentials answers, such as when the account was created.

In decision step 265, self-claim orphan account program 144 determines whether ownership credentials have been satisfied. The true answers to the ownership credentials are stored in a data file created by gather orphan account program 142. The self-claim orphan account program 144 compares the answers from the potential orphan account owner to the ownership credentials answers stored in the data file. In order for a potential orphan account owner be granted ownership, the potential orphan account owner must prove he, at one-time, had access to the account by knowing the answers to the ownership credentials questions. The ownership credentials questions are presented to the potential orphan account owner. When the potential orphan account owner answers the ownership credentials questions correctly, self-claim orphan account program 144 transitions to step 270 (decision step “YES” branch). If the ownership credentials answers are not accepted by self-claim orphan account program 144, self-claim orphan account program 144 can transition to one of the following steps: (i) step 265, present the ownership credentials questions again; (ii) step 265, present ownership credentials questions again and decrement an attempts counter to limit the number of times the potential orphan account owner is presented with the ownership credentials questions; or (iii) terminate, or suspend, and present a failure authorization message to the potential orphan account owner (decision step “NO” branch). When the potential orphan account owner fails to answer the ownership credentials questions correctly, the potential orphan account owner can either select another potential orphan account to self-claim or exit self-claim orphan account program 144.

In step 270, self-claim orphan account program 144 sends a request to computing device 130 to validate the claim of the potential orphan account owner. Sending a request may be in the form of an Extensible Markup Language (XML) message, as someone skilled in the arts would recognize.

In step 275, self-claim orphan account program 144 enters a wait loop. The wait loop, as someone skilled in the arts would recognize can be a process suspension waiting for an event. Self-claim orphan account program 144 is waiting for a notification to be received from computing device 130.

Received a request generates an event and awakes account manger software 132. Pertinent account information was sent to account manger software 132 previously in step 215 of FIG. 2A. Account manager software 132 will present pertinent account information to the account administrator, so that account validation can be determined. Regardless, the account administrator can reject the claim request for any reason. The approval or rejection notice is sent to self-claim orphan account program 144. In various embodiments, account manger software 132 may also present some type of Turing test challenge, to verify that the user is human.

In step 280, self-claim orphan account program 144 receives the approval notice. Sending a receipt of approval or rejection notice may be in the form of an Extensible Markup Language (XML) message, as someone skilled in the arts would recognize. The receipt notice will either approve or reject the claim to the potential orphan account. When the approval notice indicates approved the orphan account is re-labeled to “valid.”

In step 285, self-claim orphan account program 144 displays the approval or rejection results to the potential orphan account owner. The display can be in the form of a message screen, as someone skilled in the arts would recognize.

In step 290, self-claim orphan account program 144 updates the data file of previously potential orphan accounts that have previously been determined non-orphaned by a previous invocation of self-claim orphan account program 144. In some embodiments, rejection notices are also placed in the data file of orphan accounts that have previously been determined valid.

In decision step 295, self-claim orphan account program 144 determines whether there are more accounts that the potential account owner can self-claim. Self-claim orphan account program 144 accesses the pertinent account information data file to determine whether there are more accounts that the potential account owner can self-claim. There may be accounts on the list displayed to the potential orphan account owner; however, when a potential orphan account owner fails to claim an account, or is rejected by an account administrator, that account is grayed out as not selectable. Grayed out accounts are not counted as available to self-claim. When there are more accounts that the potential orphan account owner can self-claim, self-claim orphan account program 144 transitions back to step 260 (decision step “YES” branch). When there are no more accounts that the potential orphan account owner can self-claim, self-claim orphan account program 144 terminates (decision step “NO” branch).

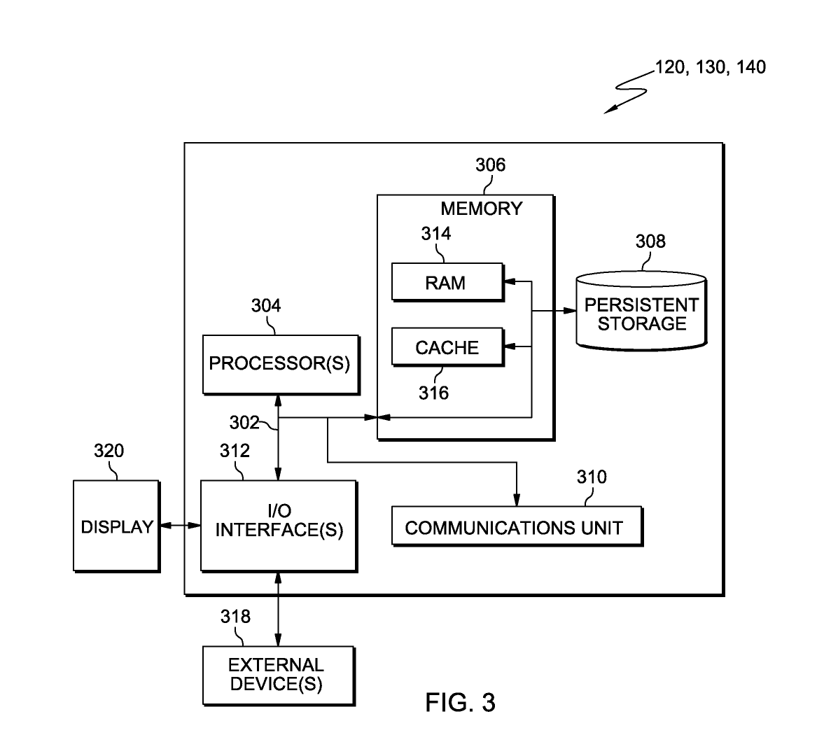

FIG. 3 depicts a block diagram of components of computing device 120, computing device 130, and server computer 140, in accordance with one embodiment of the present invention. It should be appreciated that FIG. 3 provides only an illustration of one implementation and does not imply any limitations with regard to the environments in which different embodiments may be implemented. Many modifications to the depicted environment may be made.

Computing device 120, computing device 130, and server computer 140 each include communications fabric 302, which provides communications between computer processor(s) 304, memory 306, persistent storage 308, communications unit 310, and input/output (I/O) interface(s) 312. Communications fabric 302 can be implemented with any architecture designed for passing data and/or control information between processors (such as microprocessors, communications and network processors, etc.), system memory, peripheral devices, and any other hardware components within a system. For example, communications fabric 302 can be implemented with one or more buses.

Memory 306 and persistent storage 308 are computer-readable storage media. In this embodiment, memory 306 includes random access memory (RAM) 314 and cache memory 316. In general, memory 306 can include any suitable volatile or non-volatile computer-readable storage media.

Account management software 132 is stored in persistent storage 308, of computing device 130, for execution and/or access by one or more of the respective computer processors 304 via one or more memories of memory 306. Gather orphan account program 142 and self-claim orphan account program 144 are stored in persistent storage 308, of server computer 140, for execution and/or access by one or more of the respective computer processors 304 via one or more memories of memory 306.

In this embodiment, persistent storage 308 includes a magnetic hard disk drive. Alternatively, or in addition to a magnetic hard disk drive, persistent storage 308 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 308 may also be removable. For example, a removable hard drive may be used for persistent storage 308. Other examples include optical and magnetic disks, thumb drives, and smart cards that are inserted into a drive for transfer onto another computer-readable storage medium that is also part of persistent storage 308.

Communications unit 310, in these examples, provides for communications with other data processing systems or devices, including resources of network 110 and other devices (not shown). In these examples, communications unit 310 includes one or more network interface cards. Communications unit 310 may provide communications through the use of either or both physical and wireless communications links.

Account management software 132 may be downloaded to persistent storage 308, of computing device 130, through communications unit 310 of computing device 130. Gather orphan account program 142 and self-claim orphan account program 144 may both be downloaded to persistent storage 308, of server computer 140, through communications unit 310 of server computer 140.

I/O interface(s) 312 allows for input and output of data with other devices that may be connected to computing device 120, computing device 130, and/or server computer 140. For example, I/O interface 312 may provide a connection to external devices 318 such as a keyboard, keypad, a touch screen, and/or some other suitable input device. External devices 318 can also include portable computer-readable storage media such as, for example, thumb drives, portable optical or magnetic disks, and memory cards. Software and data used to practice embodiments of the present invention, e.g., account management software 132, can be stored on such portable computer-readable storage media and can be loaded onto persistent storage 308, of computing device 130, via I/O interface(s) 312 of computing device 130. I/O interface(s) 312 also connects to display 320. Software and data used to practice embodiments of the present invention, e.g., gather orphan account program 142, can be stored on such portable computer-readable storage media and can be loaded onto persistent storage 308, of server computer 140, via I/O interface(s) 312 of server computer 140. I/O interface(s) 312 also connects to display 320. Software and data used to practice embodiments of the present invention, e.g., self-claim orphan account program 144, can be stored on such portable computer-readable storage media and can be loaded onto persistent storage 308, of server computer 140, via I/O interface(s) 312 of server computer 140. I/O interface(s) 312 also connects to display 320.

Display 320 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for resolving orphan accounts, the method comprising the steps of:
receiving information about at least one account on a computing system;
one or more processors determining, from the received information, that a first potential orphan account exists on the computing system;
one or more processors notifying a first potential account owner of the first potential orphan account about the existence of the first potential orphan account;
one or more processors receiving an ownership claim for the first potential orphan account, wherein the ownership claim indicates that the first potential account owner is an actual owner of the first potential orphan account; and
one or more processors determining whether the ownership claim is legitimate.

2. The method of claim 1, further comprising:
one or more processors generating an approval request of the ownership claim;
one or more processors receiving an indication that the ownership claim is approved; and
one or more processors granting the ownership claim.

3. The method of claim 1, wherein the step of one or more processors determining, from the received information, that the first potential orphan account exists on the computing system comprises:
one or more processors accessing an adoption policy, wherein the adoption policy includes rules that indicate circumstances when accounts on the computing system become potential orphan accounts; and
one or more processors accessing a log file for the first potential orphan account to determine if the circumstances indicated in the adoption policy exist in the log file.

4. The method of claim 1, wherein the step of one or more processors notifying the first potential account owner of the first potential orphan account about the existence of the first potential orphan account comprises;
one or more processors notifying the first potential account owner of the first potential orphan account about the existence of the first potential orphan account; and
one or more processors notifying the first potential account owner of login credentials needed to submit an ownership claim.

5. The method of claim 4, further comprising, prior to the step of one or more processors receiving an ownership claim for the first potential orphan account, wherein the ownership claim indicates that the first potential account owner is an actual owner of the first potential orphan account, the steps of:
one or more processors receiving a request to login to submit an ownership claim;
one or more processors causing a first prompt to be displayed requesting the login credentials;
one or more processors receiving the login credentials; and
one or more processors causing a second prompt to be displayed requesting entry of the ownership claim of the first potential orphan account.

6. The method of claim 1, wherein the step of one or more processors determining whether the ownership claim is legitimate comprises:
one or more processors causing a third prompt to be displayed requesting login credentials of the first potential orphan account;
one or more processors receiving the login credentials of the first potential orphan account;
one or more processors accessing a log file for the first potential orphan account to determine legitimate login credentials existing in the log file; and
one or more processors determining whether the received login credentials of the first potential orphan account match the legitimate login credentials existing in the log file.
